(19) United States
(12) Patent Application Publication
(10) Pub. No.: US 2024/0157729 A1
(43) Pub. Date: May 16, 2024

(54) Wheel and Non-Pneumatic Tire Assembly

(71) Applicant: DuPont Polymers, Inc., Wilmington, DE (US)

(72) Inventors: Mohammed Rezaul Karim, Bear, DE (US); Karl P. Maurer, North Branch, MN (US)

(21) Appl. No.: 18/497,329

(22) Filed: Oct. 30, 2023

Related U.S. Application Data
(60) Provisional application No. 63/421,003, filed on Oct. 31, 2022.

(51) Int. Cl. B60C 1/00; B60C 7/00

(52) U.S. Cl. CPC B60C 1/00; B60C 7/00; B60C 2001/0091; B60C 2007/005

(57) ABSTRACT

The present disclosure is directed to a non-pneumatic tire assembly having a sidewall portion made from a copolyether-ester. The non-pneumatic tire assembly comprises complementary annular inboard and outboard tire casing segments. Each segment comprises: a closed end and an open end, a peripheral band comprising exterior and interior surfaces, and an inner band comprising exterior and interior surfaces, the inner band being coaxially spaced radially inward from the interior surface of the peripheral band, wherein the closed end comprises a resilient and contiguous sidewall extending radially between the interior surface of the peripheral band and the exterior surface of the inner band, the sidewall comprising convex or concave exterior and interior surfaces, wherein the open end comprises a void defined by the interior surfaces of the peripheral band, the exterior surface of the inner band, and the sidewall; wherein the inner band interior surfaces of the inboard and outboard tire casing segments are configured to be disposed on an exterior rim surface of a wheel such that the open ends of each segment do not form a sealed void within the inboard and outboard segments; and wherein the annular inboard and outboard tire casing segments are each made from a composition comprising a copolyether-ester. The present disclosure is also directed to a wheel and non-pneumatic tire assembly.

### CROSS-REFERENCE TO RELATED APPLICATION

This application claims priority to and the benefit of U.S. Provisional Patent Application No. 63/421,003 filed on Oct. 31, 2022, which is incorporated by reference in its entirety.

### BACKGROUND

Existing pneumatic vehicle tires are primarily made from thermoset rubber which is not recyclable and contributes to environmental pollution. Non-pneumatic tires, or tires that are not supported by air pressure, are attractive alternatives yet thus far have not been designed a way to minimize road noise while still maintaining an aesthetic look desired for certain vehicle applications.

Existing non-pneumatic tires do not have contiguous sidewalls and instead have openings between the wheel connecting segment and the outer tread portion. A typical design is depicted in FIG. 1, which shows non-pneumatic tire 1 having outer tread portion 2 and inner wheel portion 3 with spokes 4 that have openings 5 therebetween. There are a number of disadvantages to such a design, including insufficient load bearing, issues with debris getting lodges between the spokes, and overall mechanical instability.

### SUMMARY

In accordance with one embodiment of the present disclosure, a non-pneumatic tire assembly is disclosed. The non-pneumatic tire assembly comprises complementary annular inboard and outboard tire casing segments. Each segment comprises: a closed end and an open end, a peripheral band comprising exterior and interior surfaces, and an inner band comprising exterior and interior surfaces, the inner band being coaxially spaced radially inward from the interior surface of the peripheral band, wherein the closed end comprises a resilient and contiguous sidewall extending radially between the interior surface of the peripheral band and the exterior surface of the inner band, the sidewall comprising convex or concave exterior and interior surfaces, wherein the open end comprises a void defined by the interior surfaces of the peripheral band, the exterior surface of the inner band, and the sidewall; wherein the inner band interior surfaces of the inboard and outboard tire casing segments are configured to be disposed on an exterior rim surface of a wheel such that the open ends of each segment do not form a sealed void within the inboard and outboard segments; and wherein the annular inboard and outboard tire casing segments are each made from a composition comprising a copolyether-ester.

In accordance with another embodiment of the present disclosure, a wheel and non-pneumatic tire assembly are disclosed. The wheel and non-pneumatic tire assembly comprise complementary annular inboard and outboard tire casing segments. Each segment comprises: a closed end and an open end, a peripheral band comprising exterior and interior surfaces, and an inner band comprising exterior and interior surfaces, the inner band being coaxially spaced radially inward from the interior surface of the peripheral band, wherein the closed end comprises a resilient and contiguous sidewall extending radially between the interior surface of the peripheral band and the exterior surface of the inner band, the sidewall comprising convex or concave exterior and interior surfaces, wherein the open end comprises a void defined by the interior surfaces of the peripheral band, the inner band, and the sidewall; and a wheel or wheel assembly having an exterior rim surface; wherein the inner band interior surface of the inboard and outboard tire casing segments are disposed on the exterior rim surface of the wheel such that the open ends of each segment do not form a sealed void within the inboard and outboard segments; and wherein the annular inboard and outboard tire casing segments are each made from a composition comprising a copolyether-ester.

### DESCRIPTION OF THE FIGURES

The foregoing summary, as well as the following description of the disclosure, is better understood when read in conjunction with the appended figures. For the purpose of illustrating the disclosure, the figures illustrate some, but not all, alternative embodiments. This disclosure is not limited to the precise arrangements and instrumentalities shown. The following figures, which are incorporated into and constitute part of the specification, assist in explaining the principles of the disclosure.

FIG. 1 is a front elevational view of a traditional non-pneumatic tire.

FIG. 2 is a top-front-left isometric view of an embodiment of the wheel and non-pneumatic tire assembly.

FIG. 3 is a top-interior-left isometric view of an embodiment of the inboard tire segment showing the void defined by the interior surfaces of the peripheral band, the inner band, and the sidewall.

FIG. 4 is a top-front-left isometric view of an embodiment of the outboard tire casing segment showing the resilient and contiguous sidewall extending radially between the interior surface of the peripheral band and the exterior surface of the inner band.

FIG. 5 shows the same view as that shown in FIGS. 3-4 and illustrates the complementary inboard and outboard tire casing segments coming together as a non-pneumatic tire assembly.

FIG. 6 is a top-front-left isometric and exploded view of an embodiment of the wheel and non-pneumatic tire assembly as it would be assembled.

FIG. 7 is a top-front-left isometric view of an embodiment of the wheel and non-pneumatic tire assembly in an assembled configuration without outer shear band and tread layers.

FIG. 8 is a top-front-left isometric and exploded view of an embodiment of the wheel and non-pneumatic tire assembly as it would be assembled with the outer shear band and tread layers.

FIG. 9 is a top-front-left cross-sectional view of an embodiment of the non-pneumatic tire assembly.

FIG. 10 is a top-front-left cross-sectional view of an embodiment of the wheel and non-pneumatic tire assembly with the outer shear band and tread layers, in an assembled configuration.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a non-pneumatic tire assembly. The non-pneumatic tire assembly has a particular configuration wherein the annular inboard and outboard tire casing segments are each made from a composition comprising a copolyether-ester. The present inventors have discovered that a non-pneumatic tire assembly described in this application is an improvement over designs such as those shown in FIG. 1 in that when assembled it features a contiguous and resilient sidewall which provides improved mechanical stability and allows for an aesthetic look suitable for many vehicle applications.

One embodiment of the non-pneumatic tire assembly comprises: complementary annular inboard and outboard tire casing segments, with each segment comprising: a closed end and an open end, a peripheral band comprising exterior and interior surfaces, and an inner band comprising exterior and interior surfaces, the inner band being coaxially spaced radially inward from the interior surface of the peripheral band. The closed end can comprise a resilient and contiguous sidewall extending radially between the interior surface of the peripheral band and the exterior surface of the inner band, the sidewall comprising convex or concave exterior and interior surfaces. The open end can comprise a void defined by the interior surfaces of the peripheral band, the inner band, and the sidewall. The inner band interior surfaces of the inboard and outboard tire casing segments can be configured to be disposed on an exterior rim surface of a wheel such that the open ends of each segment do not form a sealed void within the inboard and outboard segments. The annular inboard and outboard tire casing segments can each be made from a composition comprising a copolyether-ester.

This application also generally describes a wheel and non-pneumatic tire assembly. In addition to the features described above, the wheel and non-pneumatic tire assembly can comprise a wheel or wheel assembly having an exterior rim surface. The inner band interior surface of the inboard and outboard tire casing segments can be disposed on the exterior rim surface of the wheel such that the open ends of each segment do not form a sealed void within the inboard and outboard segments. The non-pneumatic tire assembly and wheel and non-pneumatic tire assembly

are suitable for most any vehicle. The term “vehicle” refers to any device that moves on wheels and transports people or freight or performs other functions. The vehicle may be self propelled or not. Non-limiting examples include automobiles, motorcycles, wheeled construction vehicles, all terrain vehicles (ATVs), trucks, trailers, bicycles, carriages, shopping carts, wheel barrows, and dollies.

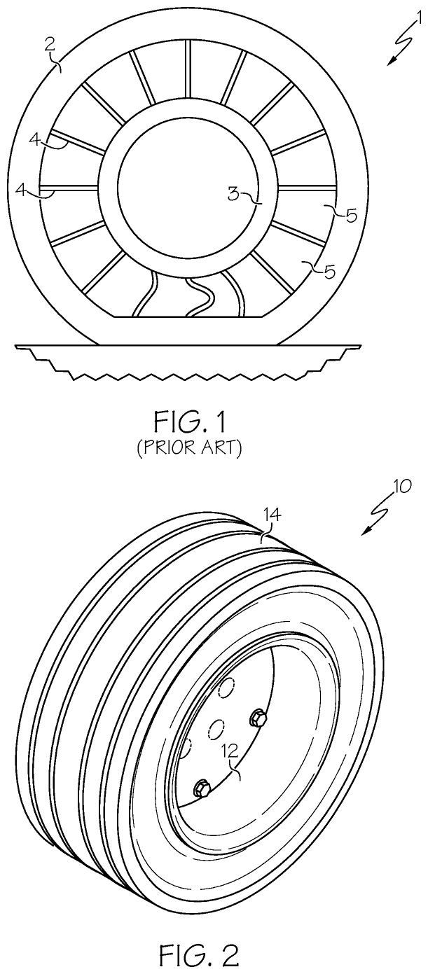

The non-pneumatic tire assembly of the present disclosure can be further described utilizing FIGS. 2-10.

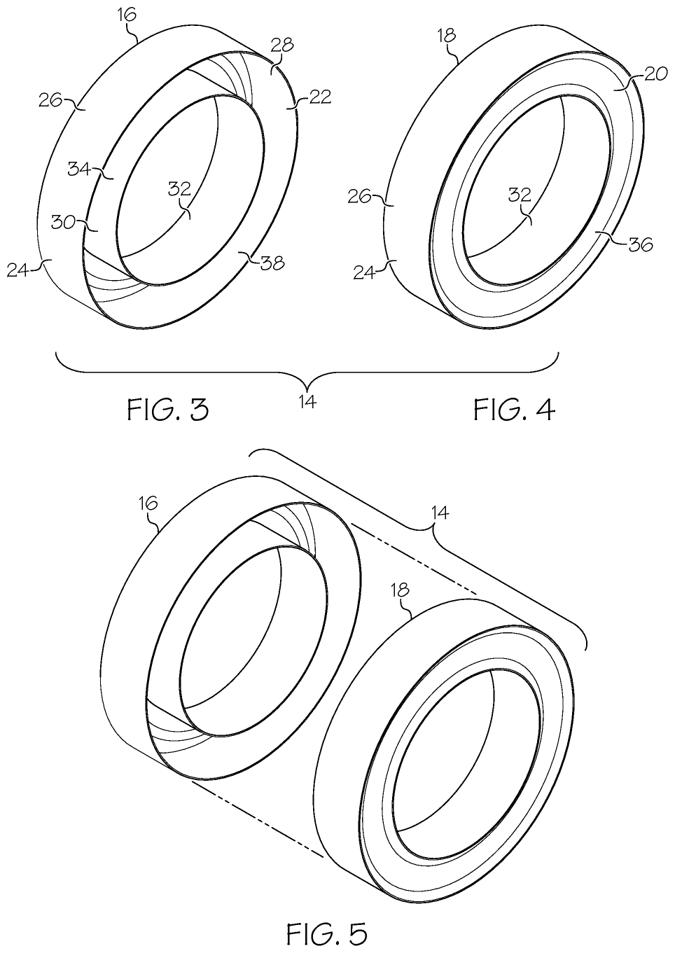

As shown in FIG. 2, an embodiment of the wheel and non-pneumatic tire assembly 10 comprises the wheel assembly 12 and non-pneumatic tire assembly 14 mounted thereon. FIG. 3 and FIG. 4 show the non-pneumatic tire assembly 14 having the annular inboard tire casing segment 16 which complements the annular outboard tire casing segment 18. The inboard and outboard tire casing segments 16 and 18 have a closed end 20 and an opposing open end. The open end 22 can be seen in the view of FIG. 3, which shows the interior of the inboard tire casing segment 16. The inboard and outboard tire casing segments 16 and 18 each comprise peripheral band 24 which has exterior surface 26. Tire casing segments 16 and 18 have an interior surface 28 of the peripheral band 24.

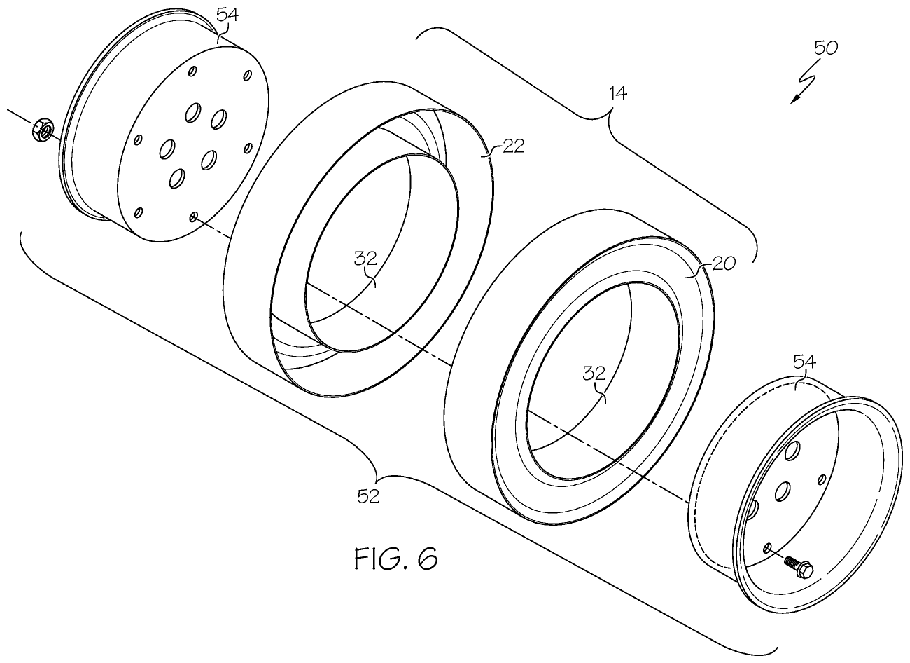

The inboard and outboard tire casing segments 16 and 18 also comprise an inner band 30 which has interior surface 32 and exterior surface 34. Inner band 30 is coaxially spaced radially inward from the interior surface 28 of peripheral band 24. The closed end 20 comprises a resilient and contiguous sidewall 36 extending radially between the interior surface 28 of peripheral band 24 and the exterior surface 34 of inner band 30. Unlike existing non-pneumatic tires, tire assembly 24 does not have a spoked configuration at the location of sidewall 36, i.e., sidewall 36 is contiguous. The sidewall 36 is also resilient, meaning that under load it will deform and spring back to an open position as a vehicle having the tire assembly moves. The open end 22 comprises a void 38 defined by the interior surface 28 of peripheral band 24, the exterior surface 34 of inner band 30, and the sidewall 36. The complementary inboard segment 16 and outboard segment 18 of tire assembly 14 are shown as they would come together for assembly in FIG. 5.

FIG. 6 shows an exploded view of an embodiment of the wheel and tire assembly 50, which includes non-pneumatic tire assembly 14 and wheel assembly 52. As described above, tire assembly 14 features a closed end 20 and an open end 22. Each segment of the wheel assembly 52 has an exterior rim surface 54. In assembly, the interior surface 32 of the inner bands are disposed on the exterior rim surface 54 of wheel assembly 52 in the manner shown in the FIG. 6 and ultimately held in place by an annular lip extending radially outward from the exterior rim surface 54 of wheel assembly 52.

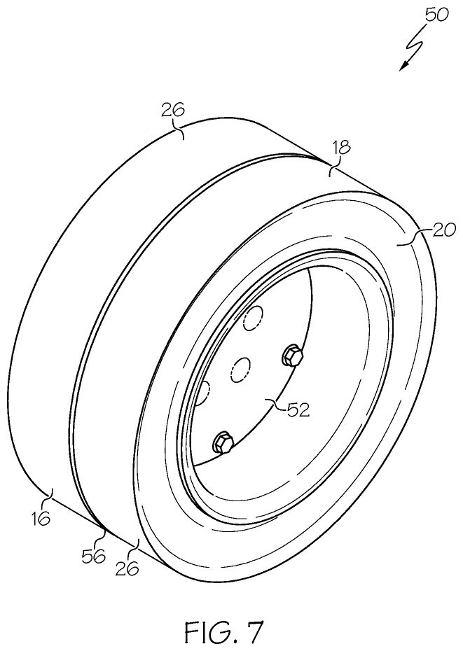

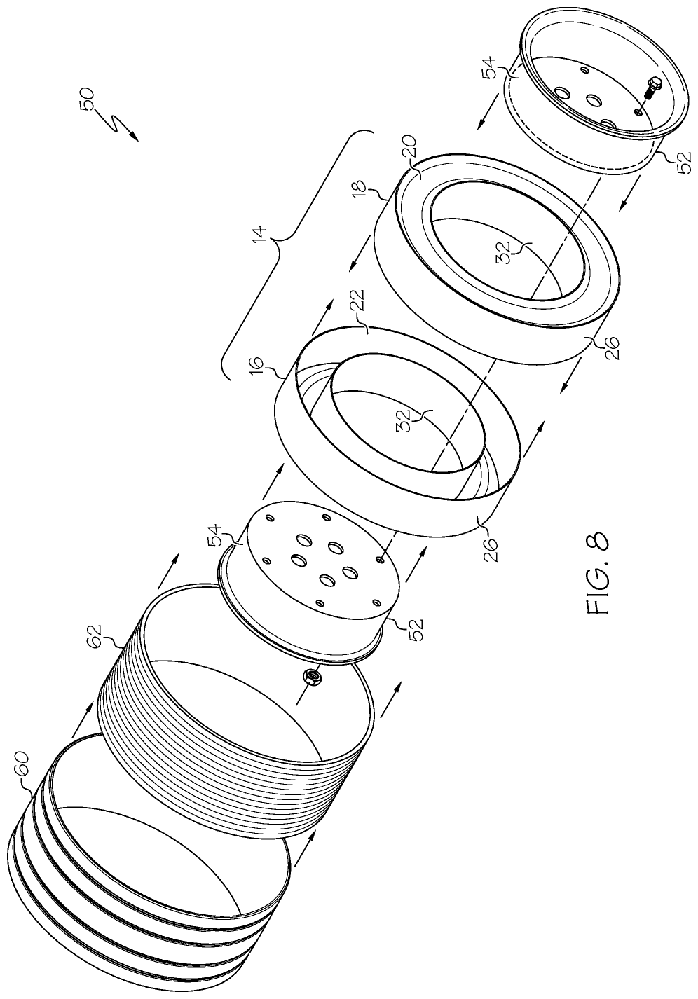

FIG. 7 shows assembled wheel and tire assembly 50 having the inboard tire segment 16 and the outboard tire segment 18 disposed on the exterior rim surface of wheel assembly 52. The exterior surface 26 of the inner and outer band is suitable for additional layers such as a tread layer or an intermediate shear band layer as described below. As depicted in FIG. 7, the closed end 20 has a convex sidewall (protruding inward toward the center of wheel assembly 52). Other embodiments can have a concave sidewall (protruding outward from the center of wheel assembly 52). In an assembled configuration, wheel and tire assembly 50 include inboard tire segment 16 and outboard tire segment 18 disposed over the exterior rim surface of wheel assembly 52 such that the open ends of each segment do not form a sealed void within the inboard and outboard tire segment. Thus, the gap 56 between the two tire segments ensures that the tire assembly remains non-pneumatic, that is, air can diffuse in and out of gap 56.

FIG. 8 shows an exploded view of an embodiment of the wheel and tire assembly 50 which further features outer tread layer 60 and intermediate shear band layer 62. As described above, each segment of the wheel assembly 52 receives complementary inboard tire segment 16 and outboard tire segment 18 at the interior surface 32 of each respective inner band and the exterior rim surface 54. The inboard and outboard segments 16 and 18 have a closed end 20 and an open end 22 as described above. In one embodiment, the wheel and tire assembly 50 can further comprise a contiguous tread layer 60 extending radially outward from exterior surface 26 of the peripheral band of the inboard and outboard tire casing segments 16 and 18. The contiguous tread layer 60 can be disposed directly on the exterior surface 26 of the peripheral band, e.g., through mechanical or chemical adhesion. Alternatively, the contiguous tread layer 60 can be disposed on an intermediate shear band layer 62 which is disposed on the exterior surface 26 of the inboard and outboard tire casing segments 16 and 18. The tread layer 60 can be rubber or reinforced rubber. The shear band layer 62 can be a thermoplastic composite or a rubber or reinforced rubber that integrates with the tread layer 60. The shear band layer may comprise a thermoplastic polymer or composite. Such layer may be an optionally reinforced polyester. Suitable materials, such as for the optionally reinforced polyester, for the shear band layer 62 include a polyethylene terephthalate or a polybutylene terephthalate.

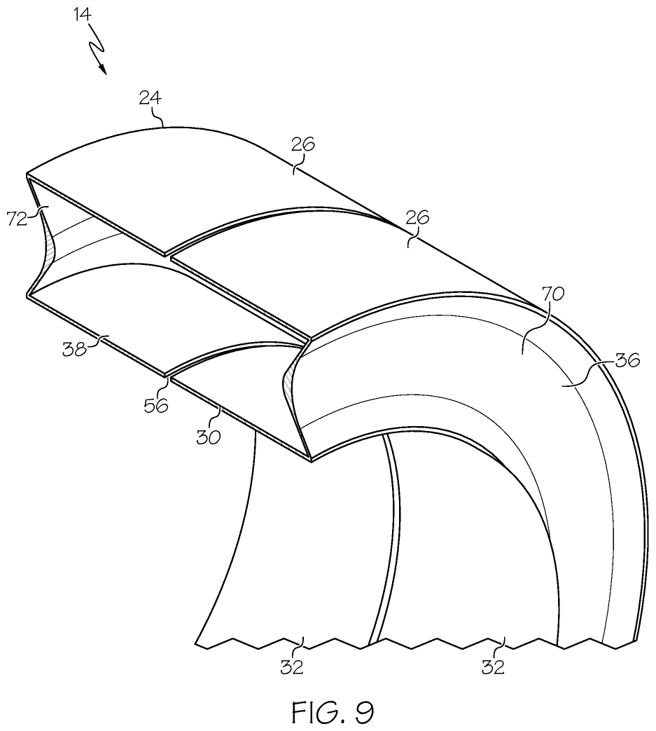

FIG. 9 shows a partial cross-sectional view of tire assembly 14, which includes the peripheral band 24, the inner band 30, and sidewall 36. As described above, the inboard and outboard tire segments do not abut in a flushed manner and instead are spaced apart by gap 56. The exterior contiguous and resilient surface 70 of the sidewall 36 can be concave as shown or convex. The open end of each respective tire casing segment comprises a void 38 defined by the interior surface of the peripheral band 24, the exterior surface of the inner band, and the interior surface 72 of the sidewall 36. The tire assembly 14 is configured to be disposed on a wheel or wheel assembly at the interior surface 32 of the inner band 30.

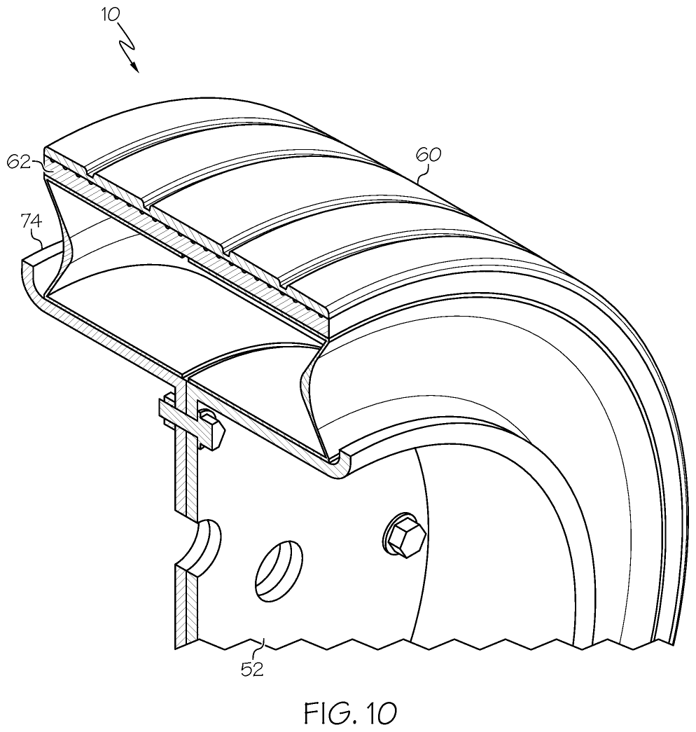

FIG. 10 shows a partial cross-sectional view of the wheel and non-pneumatic tire assembly 10, which features an outer tread layer 60 and intermediate shear band layer 62. The wheel assembly 52 is shown as two complementary wheel segments coupled by a suitable mechanical fastener such as the nut and bolt fastener shown. It will be understood that the wheel assembly 52 can be coupled together with any suitable fastener or can be joined through chemical adhesion. The wheel assembly 52 can comprise an annular lip 74 which extends radially outward from the exterior rim surface. The annular lip 74 is useful for retaining the tire assembly on the exterior rim surface during use.

### Copolyether-Ester for Tire Casing Segments or Wheel/Wheel Assemblies

The inboard and outboard tire casing segments and a portion or all of the wheel or wheel assembly can be made (e.g., injection molded) from a composition comprising a copolyether-ester. Suitable copolyether-esters have a multiplicity of recurring long-chain ester units and short-chain ester units joined head-to-tail through ester linkages, the long-chain ester units being represented by formula (A):

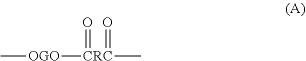

and said short-chain ester units being represented by formula (B):

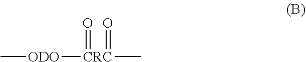

wherein

G is a divalent radical remaining after the removal of terminal hydroxyl groups from poly(alkylene oxide)glycols having a number average molecular weight of between about 400 and about 6000 Da, preferably between about 400 and about 3000 Da, even more preferably between about 600 and about 3000 Da;

R is a divalent radical remaining after removal of carboxyl groups from a dicarboxylic acid having a molecular weight of less than about 300 Da;

D is a divalent radical remaining after removal of hydroxyl groups from a diol having a molecular weight less than about 250 Da.

The term “about” as used here and elsewhere in this application refers to the stated numerical unit ±10%.

The term “long-chain ester units” as applied to units in a polymer chain refers to the reaction product of a long-chain glycol with a dicarboxylic acid. Suitable long-chain glycols are poly(alkylene oxide) glycols having terminal (or as nearly terminal as possible) hydroxy groups and having a number average molecular weight of from about 400 to about 6000 Da, preferably from about 600 to about 3000 Da, even more preferably between about 600 and about 3000 Da, even more preferably between about 1000 to about 3000 Da, even more preferably between 1000 to about 2000 Da. In addition, the long-chain glycols may have a melting point of less than about 65° C., such as less than about 60° C., such as less than about 55° C., such as less than about 50° C. The long chain glycols are generally poly(alkylene oxide) glycols or glycol esters of poly(alkylene oxide) dicarboxylic acids. Preferred poly(alkylene oxide) glycols include poly(tetramethylene oxide) glycol, poly(trimethylene oxide) glycol, poly(propylene oxide) glycol, poly(ethylene oxide) glycol, poly(hexamethylene oxide) glycol, poly(heptamethylene oxide) glycol, poly(octamethylene oxide) glycol, poly(nonamethylene oxide) glycol, and poly(1,2-butylene oxide) glycol, copolymer glycols of these alkylene oxides, and block copolymers such as ethylene oxide-capped poly(propylene oxide) glycol. Mixtures of two or more of these glycols can be used. Long chain ester units of Formula (A) may also be referred to as “soft segments” of a copolyether-ester polymer.

The term “short-chain ester units” as applied to units in a polymer chain of the copolyether-esters refers to low molecular weight compounds or polymer chain units having molecular weights less than about 550 Da, such as less than about 525 Da, such as less than about 500 Da, such as less than about 475 Da, such as less than about 450 Da. They are made by reacting a low molecular weight diol or a mixture of diols (molecular weight below about 250 Da, such as below about 225 Da, such as below about 200 Da, such as below about 175 Da, such as below about 150 Da) with a dicarboxylic acid to form ester units represented by Formula (B) above. Short chain ester units of Formula (B) may also be referred to as “hard segments” of the copolyether-ester polymer.

Included among the low molecular weight diols which react to form short-chain ester units for preparing copolyesters are acyclic, alicyclic and aromatic dihydroxy compounds. Low molecular weight diols which react to form short-chain ester units include aliphatic diols containing 2 to 8 carbon atoms, such as about 2 to about 6 carbon atoms, such as ethylene, propylene, isobutylene, tetramethylene, 1,4-pentamethylene, 2,2-dimethyltrimethylene, hexamethylene and decamethylene glycols, dihydroxycyclohexane, cyclohexane dimethanol, resorcinol, hydroquinone, 1,5-dihydroxynaphthalene, and the like. In particular, the diol may be an aliphatic diol, such as 1,4-butanediol, ethylene glycol, 1,3-propanediol, cyclohexanedimethanol, and/or hexamethylene glycol. For instance, the diol may be ethylene glycol, 1,4 butanediol, 1,3-propane diol, or a combination thereof. In particular, the diol may be 1,4 butanediol, 1,3-propane diol, or a combination thereof. In one embodiment, 1,4-butanediol is preferred. In another embodiment, ethylene glycol is preferred. In another further embodiment, 1,3-propanediol is preferred. In one embodiment, 1,4-butanediol may be provided as a mixture with ethylene glycol, 1,3-propanediol, cyclohexanedimethanol, and/or hexamethylene glycol. Included among the bisphenols which can be used are bis(p-hydroxy)diphenyl, bis(p-hydroxyphenyl)methane, and bis(p-hydroxyphenyl)propane. Equivalent ester-forming derivatives of diols are also useful (e.g., ethylene oxide or ethylene carbonate can be used in place of ethylene glycol or resorcinol diacetate can be used in place of resorcinol). The term “diols” includes equivalent ester-forming derivatives such as those mentioned. For example, ethylene oxide or ethylene carbonate can be used in place of ethylene glycol. The molecular weights refer to the diols, not to the ester-forming derivatives.

Dicarboxylic acids that can react with long-chain glycols and low molecular weight diols to produce the copolyether-esters are aliphatic, cycloaliphatic or aromatic dicarboxylic acids of a low molecular weight (e.g., having a molecular weight of less than about 300 Da, such as less than about 275 Da, such as less than about 250 Da, such as less than about 225 Da). The term “dicarboxylic acids” includes functional equivalents of dicarboxylic acids that have two carboxyl functional groups that perform substantially similarly to dicarboxylic acids in reaction with glycols and diols in forming copolyether-ester polymers. These equivalents include esters and ester-forming derivatives such as acid halides and anhydrides. The molecular weight in this context pertains to the acid and not to its equivalent ester or ester-forming derivative. Thus, an ester of a dicarboxylic acid having a molecular weight greater than 300 or a functional equivalent of a dicarboxylic acid having a molecular weight greater than 300 are also suitable, provided the corresponding acid has a molecular weight below about 300 or the aforementioned molecular weights.

Aliphatic dicarboxylic acids refer to carboxylic acids having two carboxyl groups, each attached to a saturated carbon atom. If the carbon atom to which the carboxyl group is attached is saturated and is in a ring, the acid is cycloaliphatic. Aliphatic or cycloaliphatic acids having conjugated unsaturation often may not be used because of homopolymerization. However, some unsaturated acids, such as maleic acid, may be used.

Aromatic dicarboxylic acids can be used. The term “aromatic dicarboxylic acids” refers to dicarboxylic acids having two carboxyl groups each attached to a carbon atom in a carbocyclic aromatic ring structure. It is not necessary that both functional carboxyl groups be attached to the same aromatic ring and where more than one ring is present, they can be joined by aliphatic or aromatic divalent radicals or divalent radicals such as —O— or —SO₂—.

Suitable aliphatic and cycloaliphatic acids that can be used include, but are not limited to, sebacic acid; 1,3-cyclohexane dicarboxylic acid; 1,4-cyclohexane dicarboxylic acid; adipic acid; glutaric acid; succinic acid; 4-cyclohexane-1,2-dicarboxylic acid; 2-ethylsuberic acid; cyclopentanedicarboxylic acid, decahydro-1,5-naphthylene dicarboxylic acid; 4,4′-bicyclohexyl dicarboxylic acid; decahydro-2,6-naphthylene dicarboxylic acid; 4,4′-methylenebis (cyclohexyl) carboxylic acid; 3,4-furan dicarboxylic acid; and mixtures thereof. In one embodiment, the preferred acid may include a cyclohexane dicarboxylic acid and/or adipic acid.

Suitable aromatic dicarboxylic acids include phthalic, terephthalic and isophthalic acids; dibenzoic acid; substituted dicarboxy compounds with two benzene nuclei such as bis(p-carboxyphenyl)methane; p-oxy-1,5-naphthalene dicarboxylic acid; 2,6-naphthalene dicarboxylic acid; 2,7-naphthalene dicarboxylic acid; 4,4′-sulfonyl dibenzoic acid and C₁-C₁₂ alkyl and ring substitution derivatives thereof, such as halo, alkoxy, and aryl derivatives. Hydroxy acids such as p-(beta-hydroxyethoxy)benzoic acid can also be used provided an aromatic dicarboxylic acid is also used. Aromatic acids with 8 to 16 carbon atoms are suitable, including terephthalic acid, isophthalic acid, and mixtures of phthalic acid and isophthalic acid.

In one embodiment, an aromatic dicarboxylic acid is preferred for preparing the copolyether-ester. Among the aromatic dicarboxylic acids, those with 8 to 16 carbon atoms, such as 8 to 12 carbon atoms, such as 8 to 10 caron atoms may be preferred. In particular, the aromatic dicarboxylic acid may include terephthalic acid, phthalic acid, and/or isophthalic acid. In particular, the aromatic dicarboxylic acid may include terephthalic acid, isophthalic acid, or a combination thereof. In one embodiment, the aromatic acid may include terephthalic acid alone or with a mixture of phthalic acid and/or isophthalic acid.

When a mixture of two or more dicarboxylic acids is used to prepare the copolyether-ester, isophthalic acid may be a preferred second dicarboxylic acid in one embodiment. For instance, isophthalic acid may be provided in a mixture with terephthalic acid. In this regard, the amount of copolymerized isophthalate residues in the copolyether-ester may be less than 35 mole %, such as less than 30 mole %, such as less than 25 mole %. Similarly, copolymerized isophthalate residues in the copolyether-ester may be less than 35 wt. %, such as less than 30 wt. %, such as less than 25 wt. %, based on the total weight of copolymerized dicarboxylic acid residues —(—C(O)RC(O)—)— in the copolyether-ester. The remainder of the phenylene diradicals may be derived from terephthalic acid based on the total number of moles of copolymerized dicarboxylic acid residues —(—C(O)RC(O)—)— in the copolyether-ester.

In addition, in one embodiment, at least about 70 mol. % of the groups represented by R in Formulae (A) and (B) above may be 1,4-phenylene radicals and at least about 70 mol. % of the groups represented by D in Formula (B) above may be 1,4-butylene radicals and the sum of the percentages of R groups which are not 1,4-phenylene radicals and D groups which are not 1,4-butylene radicals may not exceed 30 mol. %.

For example, the copolyether-ester may have hard segments composed of polybutylene terephthalate and about 5 wt. % to about 80 wt. %, such as about 5 wt. %

to about 75 wt. %, such as about 10 wt. % to about 70 wt. %, such as about 10 wt. % to about 60 wt. %, such as about 20 wt. % to about 60 wt. %, of soft segments composed of the reaction product of a polyether glycol and an aromatic diacid. The polyether blocks may be derived from polytetramethylene glycol. Complementarily, the fraction of hard segments may be about 20 wt. % to about 95 wt. %, such as about 20 wt. % to about 90 wt. %, such as about 30 wt. % to about 90 wt. %, such as about 40 wt. % to about 90 wt. %, such as about 40 wt. % to about 80 wt. %.

While not limited, preferred copolyether-esters may include those prepared from monomers comprising the following: (A) (1) poly(tetramethylene oxide) glycol, (2) a dicarboxylic acid selected from isophthalic acid, terephthalic acid or a mixture thereof, and (3) a diol selected from 1,4-butanediol, 1,3-propanediol or a mixture thereof; (B) (1) poly(trimethylene oxide) glycol, (2) a dicarboxylic acid selected from isophthalic acid, terephthalic acid or a mixture thereof, and (3) a diol selected from 1,4-butanediol, 1,3-propanediol or a mixture thereof; or (C) (1) ethylene oxide-capped poly(propylene oxide) glycol; (2) a dicarboxylic acid selected from isophthalic acid, terephthalic acid or a mixture thereof; and (3) a diol selected from 1,4-butanediol, 1,3-propanediol or a mixture thereof.

Preferably, the copolyether-esters may be prepared from esters or mixtures of esters of terephthalic acid or isophthalic acid, 1,4-butanediol and poly(tetramethylene ether)glycol, poly(trimethylene ether) glycol, or ethylene oxide-capped polypropylene oxide glycol or may be prepared from esters of terephthalic acid (e.g., dimethylterephthalate), 1,4-butanediol and poly(ethylene oxide)glycol). More preferably, the copolyether-esters may be prepared from esters of terephthalic acid (e.g., dimethylterephthalate), 1,4-butanediol and poly(tetramethylene ether)glycol.

For instance, in one particular embodiment, the copolyether-ester may have the following formula: -[4GT]ₓ-[BT]_{y}-, wherein 4G is the residue of butylene glycol, such as 1,4-butane diol, B is the residue of poly(tetramethylene ether glycol) and T is terephthalate, and wherein x is from about 0.60 to about 0.99 and y is from about 0.01 to about 0.40.

In one aspect, the copolyether-ester can be a block copolymer of polybutylene terephthalate and polyether segments and can have a structure as follows:

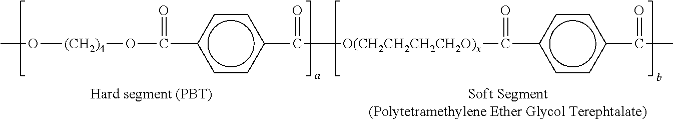

wherein a and b are integers and can vary from 2 to 10,000. The ratio between hard segments and soft segments in the block copolymer as described above can be varied in order to vary the properties of the elastomer.

In general, the copolyether-ester preferably comprises about 1 wt. % or more, such as about 5 wt. % or more, such as about 10 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more of copolymerized residues of long-chain ester units corresponding to Formula (A) above (hard segments). The copolyether-ester preferably comprises about 85 wt. % or less, such as about 80 wt. % or less, such as about 75 wt. % or less, such as about 70 wt. % or less, such as about 65 wt. % or less, such as about 60 wt. % or less of copolymerized residues of long-chain ester units corresponding to Formula (A) above (hard segments).

In general, the copolyether-ester preferably comprises about 15 wt. % or more, such as about 20 wt. % or more, such as about 25 wt. % or more, such as about 30 wt. % or more, such as about 35 wt. % or more, such as about 40 wt. % or more, such as about 45 wt. % or more, such as about 50 wt. % or more of copolymerized residues of short-chain ester units corresponding to Formula (B) above (soft segments). The copolyether-ester preferably comprises about 99 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 65 wt. % or less, such as about 60 wt. % or less, such as about 55 wt. % or less of copolymerized residues of short-chain ester units corresponding to Formula (B) above (soft segments).

In one embodiment, the copolyether-ester may comprise only copolymerized residues of long-chain ester units corresponding to Formula (A) above and short-chain ester units corresponding to Formula (B) above. In this regard, the weight percentages of the copolymerized units of Formula (A) and Formula (B) in the copolyether-ester may be complementary. That is, the sum of the weight percentages of the copolymerized units of Formula (A) and Formula (B) may be 100 wt. %. Similarly, the mole percentages of the R groups in the copolymerized units of Formula (A) and Formula (B) in the copolyether-ester may be complementary. That is, the sum of the mole percentages of the R groups in the copolymerized units of Formula (A) and Formula (B) may be 100 mol %.

Furthermore, it should be understood that a mixture of two or more copolyether-esters can be used. In one embodiment, the composition may contain one copolyether-ester as defined herein. In other embodiments, the composition may include a mixture of copolyether-esters. For instance, more than one copolyether-ester, such as two or three copolyether-esters, may be utilized in the composition.

Specifically, regarding the copolyether-esters, in particular a mixture of copolyether-esters, each copolyether-esters used need not on an individual basis come within the values set forth above. In this regard, the mixture of two or more copolyether-esters may conform to the values described herein for the copolyether-esters on a weighted average basis, however. For example, in a mixture that contains equal amounts of two copolyether-esters, one copolyether-ester can contain 60 weight percent short-chain ester units and the other copolyether-ester can contain 30 weight percent short-chain ester units for a weighted average of 45 weight percent short-chain ester units.

Regarding the properties of the copolyether-ester, it may be desired to have a melt flow that can allow it to be processed in a relatively easy manner for the formation of a composition and resulting part/article as disclosed herein. In this regard, the copolyether-ester may exhibit a relatively low melt viscosity as indicated by the melt flow rate. For instance, the melt flow rate of the copolyether-ester may be about 0.5 g/10 min or more, such as about 1 g/10 min or more, such as about 2 g/10 min or more, such as about 3 g/10 min or more, such as about 4 g/10 min or more, such as about 5 g/10 min or more. The melt flow rate may be about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The copolyether-ester may also have a relatively low melting temperature. For instance, the melting temperature may be about 100° C. or more, such as about 110° C. or more, such as about 130° C. or more, such as about 150° C. or more, such as about 170° C. or more, such as about 190° C. or more, such as about 200° C.or more, such as about 220° C. or more, such as about 240° C. or more. The melting temperature may be about 300° C. or less, such as about 280° C. or less, such as about 250° C. or less, such as about 230° C. or less, such as about 210° C. or less, such as about 200° C. or less, such as about 180° C. or less, such as about 160° C. or less, such as about 140° C. or less, such as about 120° C. or less. The melting temperature may be determined using means known in the art, such as differential scanning calorimetry in accordance with ISO 11357-1:2023 at a rate of 10° C./min.

In addition, the glass transition temperature of the copolyether-ester may be within a particular range. For instance, the glass transition temperature may be about −80° C. or more, such as about −70° C. or more, such as about −60° C. or more, such as about −50° C. or more, such as about −40° C. or more, such as about −30° C. or more. The glass transition temperature may be about 0° C. or less, such as about −5° C. or less, such as about −10° C. or less, such as about −20° C. or less, such as about −30° C. or less, such as about −40° C. or less. Also, the glass transition temperature of the hard segment of the copolyether-ester may be within a particular range. For instance, the glass transition temperature of the hard segment may be about 30° C. or more, such as about 35° C. or more, such as about 40° C. or more, such as about 45° C. or more, such as about 50° C. or more, such as about 55° C. or more, such as about 60° C. or more, such as about 65° C. or more, such as about 70° C. or more, such as about 75° C. or more, such as about 80° C. or more. The glass transition temperature may be about 150° C. or less, such as about 140° C. or less, such as about 130° C. or less, such as about 120° C. or less, such as about 110° C. or less, such as about 100° C. or less, such as about 90° C. or less, such as about 80° C. or less, such as about 70° C. or less, such as about 60° C. or less, such as about 55° C. or less, such as about 50° C. or less, such as about 45° C. or less, such as about 40° C. or less, such as about 35° C. or less, such as about 30° C. or less. The glass transition temperature may be determined using means known in the art, such as differential scanning calorimetry in accordance with ISO 11357-1:2023 at a rate of 10° C./min.

Further, the copolyether-ester may have a particular density. For instance, the density be about 1 g/cm³ or more, such as about 1.03 g/cm³ or more, such as about 1.05 g/cm³ or more, such as about 1.08 g/cm³ or more, such as about 1.1 g/cm³ or more, such as about 1.15 g/cm³ or more, such as about 1.2 g/cm³ or more, such as about 1.3 g/cm³ or more. The copolyether-ester may have a density of about 2 g/cm3 or less, such as about 1.8 g/cm³ or less, such as about 1.6 g/cm³ or less, such as about 1.4 g/cm³ or less, such as about 1.3 g/cm³ or less, such as about 1.25 g/cm³ or less, such as about 1.2 g/cm³ or less, such as about 1.18 g/cm³ or less, such as about 1.15 g/cm³ or less, such as about 1.12 g/cm³ or less, such as about 1.1 g/cm³ or less. The density may be determined in accordance with ISO 1183-1:2019.

In addition, the copolyether-ester utilized may exhibit a certain mechanical strength. In particular, the copolyether-ester may not be as likely to resist deformation in bending compared to other types of materials and as a result, the copolyether-ester may exhibit a relatively low flexural modulus. For instance, the flexural modulus may be about 300 MPa or less, such as about 260 MPa or less, such as about 220 MPa or less, such as about 200 MPa or less, such as about 190 MPa or less, such as about 180 MPa or less, such as about 170 MPa or less, such as about 160 MPa or less, such as about 150 MPa or less, such as about 140 MPa or less, such as about 130 MPa or less, such as about 120 MPa or less, such as about 110 MPa or less, such as about 100 MPa or less, such as about 90 MPa or less, such as about 80 MPa or less, such as about 70 MPa or less, such as about 60 MPa or less, such as about 50 MPa or less, such as about 40 MPa or less, such as about 30 MPa or less, such as about 20 MPa or less. The flexural modulus may be about 10 MPa or more, such as about 15 MPa or more, such as about 20 MPa or more, such as about 25 MPa or more, such as about 30 MPa or more, such as about 35 MPa or more, such as about 40 MPa or more, such as about 45 MPa or more, such as about 50 MPa or more, such as about 60 MPa or more, such as about 70 MPa or more, such as about 80 MPa or more, such as about 90 MPa or more, such as about 100 MPa or more, such as about 110 MPa or more, such as about 120 MPa or more, such as about 130 MPa or more, such as about 140 MPa or more, such as about 150 MPa or more, such as about 180 MPa or more, such as about 200 MPa or more. The flexural modulus may be determined in accordance with ISO 178:2019 at a temperature of about 23° C.

Relatedly, the copolyether-ester may have a particular Shore D hardness, which can provide an indication of the resistance to indentation of the copolyether-ester. In this regard, the Shore D hardness may be about 15 or more, such as about 20 or more, such as about 25 or more, such as about 30 or more, such as about 35 or more, such as about 40 or more, such as about 45 or more, such as about 50 or more. The Shore D hardness may be about 60 or less, such as about 55 or less, such as about 50 or less, such as about 45 or less, such as about 40 or less, such as about 35 or less, such as about 30 or less. Such hardness may allow for the copolyether-ester to provide the compliance necessary to effectively function for use in a particular application. The Shore D hardness may be determined in accordance with ISO 868-2003 (15 seconds).

In addition, the copolyether-ester may have other beneficial mechanical properties. For instance, the tensile stress at break may be about 45 MPa or less, such as about 40 MPa or less, such as about 35 MPa or less, such as about 30 MPa or less, such as about 30 MPa or less, such as about 25 MPa or less. The tensile stress at break may be about 5 MPa or more, such as about 10 MPa or more, such as about 15 MPa or more, such as about 20 MPa or more, such as about 25 MPa or more, such as about 30 MPa or more, such as about 35 MPa or more. The tensile stress at break may be determined in accordance with ISO 527-1/-2 (2012) at a temperature of about 23° C.

Also, the copolyether-ester may have a relatively high nominal strain at break. For instance, the nominal strain at break may be about 500% or more, such as about 550% or more, such as about 600% or more, such as about 650% or more, such as about 700% or more, such as about 750% or more, such as about 800% or more, such as about 850% or more. The nominal strain at break may be about 2000% or less, such as about 1800% or less, such as about 1600% or less, such as about 1400% or less, such as about 1200% or less, such as about 1100% or less, such as about 1000% or less, such as about 950% or less, such as about 900% or less, such as about 850% or less, such as about 800% or less. The nominal strain at break may be determined in accordance with ISO 527-1/-2 (2012) at a temperature of about 23° C.

Suitable copolyether-esters are also described in PCT/US19/49060 (published as WO/2020/047406), which is incorporated into this application by reference for its teaching of copolyether-esters. Specific copolyether-esters are commercially available from DuPont Specialty Products USA, LLC, of Wilmington, DE, under the Hytrel® trademark.

The composition may generally comprise about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more of the copolyether-ester based on the weight of the composition. The composition may comprise less than 100 wt. %, such as about 98 wt. % or less, such as about 95 wt. % or less, such as about 93 wt. % or less, such as about 90 wt. % or less, such as about 87 wt. % or less, such as about 85 wt. % or less, such as about 83 wt. % or less, such as about 80 wt. % or less, such as about 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less of the copolyether-ester based on the weight of the composition.

### Optional Additives for Composition for Tire Casing Segments or Wheel/Wheel Assemblies

In addition to the copolyether-ester, the copolyether-ester composition for the tire casing segments or wheel/wheel assemblies may also include other optional additives as necessary to provide a resulting composition with the desired properties.

For instance, the composition may optionally include other additives as generally known in the art. These may include, but are not limited to, compatibilizers, pigments, colorants, dyes, dispersants, flame retardants, antioxidants, conductive particles, UV-inhibitors, UV-stabilizers, adhesion promoters, fatty acids, esters, paraffin waxes, neutralizers, tackifiers, dessicants, stabilizers, light stabilizers, light absorbers, coupling agents, plasticizers, lubricants, blocking agents, anti-blocking agents, antistatic agents, waxes, nucleating agents, slip agents, acid scavengers, metal deactivators, lubricants, adjuvants, polymeric additives, rubbers/elastomers, preservatives, thickeners, rheology modifiers, humectants, reinforcing and non-reinforcing fillers, and combinations thereof.

Such other additives may be provided in an amount as necessary. For instance, the additive, individually or in combination, may be provided in an amount of about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more, such as about 15 wt. % or more, such as about 20 wt. % or more, such as about 25 wt. % or more based on the weight of the composition. The additive, individually or in combination, may be provided in an amount of about 40 wt. % or less, such as about 35 wt. % or less, such as about 30 wt. % or less, such as about 25 wt. % or less, such as about 20 wt. % or less, such as about 18 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.5 wt. % or less, such as about 1.3 wt. % or less, such as about 1 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less based on the weight of the composition.

### Polymer-Based Materials or Compositions for Wheel or Wheel Assembly

Embodiments of the wheel assembly can be made from any suitable polymer-based material or composition. Suitable examples include a thermoplastic polyamide composition such as that described in PCT/US2012/052847 (published as WO 2013/033201), which is incorporated by reference into this application for its teachings of thermoplastic polyamide compositions. Other examples include copolyether-esters such as those described in PCT/US19/49060 (published as WO/2020/047406), which is incorporated into this application by reference for its teaching of copolyether-esters, as well as those described above. One non-limiting example of a copolyether-ester is commercially available from DuPont Specialty Products USA, LLC, of Wilmington, DE, under the Hytrel@ trademark (e.g., Hytrel® TPC-ET). Another example includes a polyester composition including a polyester, such as polybutylene terephthalate and/or polyethylene terephthalate. Other suitable polymer-based materials include Crastin®, polybutylene terephthalate (PBT) based polymers, Rynite®, polyamide based polymers, polyethylenimine based polymers, polyphthalamide based polymers, polyphenylene sulfide based polymers, and polyethylene terephthalate based polymers.

In one embodiment, the composition and polymer may include a copolyether-ester. For instance, the copolyether-ester may be one as described above.

In one embodiment, the composition and polymer may include a polyester. The polyester may be a thermoplastic polyester, a thermoset polyester, or a mixture thereof. In one embodiment, the polyester may be a thermoplastic polyester. In another embodiment, the polyester may be a thermoset polyester.

In general, the polyester may be derived from a diol having from 2 to 10 carbon atoms. For instance, such diol may be an aliphatic diol, a cycloaliphatic diol, or a mixture thereof. In one embodiment, such diol may be an aliphatic diol. In addition to the diol, the polyester may also be derived from a dicarboxylic acid. For instance, such dicarboxylic acid may be an aliphatic dicarboxylic acid, a dicarboxylic acid, or a mixture thereof. In one embodiment, such dicarboxylic acid may be an aromatic dicarboxylic acid.

The diol is not necessarily limited by the present disclosure. For instance, the diol may be ethylene glycol, 1,4-butanediol, cyclohexane dimethanol (e.g., 1,4-cyclohexanedimethanol), propylene glycol, 1,6-hexanediol, neopentyl glycol, decamethylene glycol, poly(oxy)ethylene glycol, polytetramethylene glycol, polymethylene glycol, or a mixture thereof. In one embodiment, the diol may be ethylene glycol. In another embodiment, the diol may be 1,4-butanediol. In a further embodiment, the diol may be 1,4-cyclohexanedimethanol.

In one embodiment, the diol may be an alkylene glycol. For instance, such a glycol may include, but is not limited to, ethylene glycol, propylene glycol, 1,4-butanediol, or a mixture thereof.

The acid is not necessarily limited by the present disclosure. For instance, the acid may be adipic acid, sebacic acid, succinic acid, oxalic acid, isophthalic acid, terephthalic acid, or a mixture thereof. In one embodiment, the acid may be an aliphatic acid. In this regard, the acid may be adipic acid, sebacic acid, succinic acid, oxalic acid, or a mixture thereof. In one embodiment, the acid may be an aromatic acid. In this regard, the acid may be isophthalic acid, terephthalic acid, or a mixture thereof.

In one embodiment, the acid may be isophthalic acid. In another embodiment, the acid may be terephthalic acid. In a further embodiment, the acid may be a mixture of isophthalic acid and terephthalic acid. In this regard, with respect to the aforementioned aromatic acids, such acid may include at least one aromatic nucleus. However, it should be understood that fuse rings may also be utilized. In this regard, the acid may also include 1,4-, 1,5-, or 2,6-naphthalene-dicarboxylic acid.

The polyester may comprise a polyalkylene terephthalate. While the polyester is not necessarily limited by the present disclosure, the polyester may include, but is not limited to, polyethylene terephthalate, polybutylene terephthalate, and polycyclohexanedimethylene terephthalate, etc. as well as mixtures thereof and copolymers thereof. In one embodiment, the polyester may be polyethylene terephthalate. In another embodiment, the polyester may be polybutylene terephthalate. In a further embodiment, the polyester may be polycyclohexanedimethylene terephthalate.

Related, the polyester may comprise a polyalkylene naphthalate. For instance, the polyester may be polyethylene naphthalate and polybutylene naphthalate, or a mixture thereof. In one embodiment, the polyester may be polyethylene naphthalate. In another embodiment, the polyester may be polybutylene naphthalate.

In addition, the polyester may be synthesized using methods generally known in the art. For instance, the polyester may be synthesized using standard condensation polymerization conditions as generally known in the art.

Regarding the properties of the polyester, it may be desired to have a melt flow that can allow it to be processed in a relatively easy manner for the formation of a polyester composition as well as resulting molded part/article. In this regard, the polyester may exhibit a relatively low melt viscosity as indicated by the melt flow rate. For instance, the melt flow rate of the polyester may be about 0.5 g/10 min or more, such as about 1 g/10 min or more, such as about 2 g/10 min or more, such as about 3 g/10 min or more, such as about 4 g/10 min or more, such as about 5 g/10 min or more, such as about 10 g/10 min or more, such as about 20 g/10 min or more, such as about 30 g/10 min or more, such as about 40 g/10 min or more, such as about 60 g/10 min or more, such as about 80 g/10 min or more. The melt flow rate may be about 100 g/10 min or less, such as about 90 g/10 min or less, such as about 80 g/10 min or less, such as about 70 g/10 min or less, such as about 60 g/10 min or less, such as about 50 g/10 min or less, such as about 40 g/10 min or less, such as about 30 g/10 min or less, such as about 20 g/10 min or less, such as about 10 g/10 min or less, such as about 8 g/10 min or less, such as about 6 g/10 min or less, such as about 5 g/10 min or less, such as about 4 g/10 min or less, such as about 3 g/10 min or less. The melt flow rate may be determined at 220° C. under a 2.16 kg load according to ISO1133.

The polyester may have a certain melting temperature. For instance, the melting temperature may be about 60° C. or more, such as about 80° C. or more, such as about 100° C. or more, such as about 120° C. or more, such as about 140° C. or more, such as about 160° C. or more, such as about 180° C. or more, such as about 200° C.or more, such as about 220° C. or more, such as about 240° C. or more, such as about 260° C. or more, such as about 280° C. or more. The melting temperature may be about 400° C. or less, such as about 380° C. or less, such as about 360° C. or less, such as about 340° C. or less, such as about 320° C. or less, such as about 300° C. or less, such as about 280° C. or less, such as about 250° C.or less, such as about 230° C. or less, such as about 210° C. or less, such as about 200° C. or less, such as about 180° C. or less, such as about 160° C. or less, such as about 140° C. or less, such as about 120° C. or less, such as about 100° C. or less. The melting temperature may be determined using means known in the art, such as differential scanning calorimetry in accordance with ISO 11357-1:2023 at a rate of 10° C./min.

In addition, the glass transition temperature of the polyester, in particular the thermoplastic polyester, may be within a particular range. For instance, the glass transition temperature may be about 0° C. or more, such as about 10° C. or more, such as about 20° C. or more, such as about 30° C. or more, such as about 40° C. or more, such as about 50° C. or more, such as about 60° C. or more, such as about 70° C. or more, such as about 80° C. or more, such as about 90° C. or more, such as about 100° C. or more, such as about 120° C. or more, such as about 140° C. or more, such as about 160° C. or more, such as about 180° C. or more. The glass transition temperature may be about 220° C. or less, such as about 200° C. or less, such as about 190° C. or less, such as about 170° C. or less, such as about 150° C.or less, such as about 130° C. or less, such as about 110° C.or less, such as about 100° C. or less, such as about 90° C. or less, such as about 80° C. or less, such as about 70° C. or less, such as about 60° C. or less. The glass transition temperature may be determined using means known in the art, such as differential scanning calorimetry in accordance with ISO 11357-1:2023 at a rate of 10° C./min.

Further, the polyester may have a particular density. For instance, the density be about 1 g/cm³ or more, such as about 1.1 g/cm³ or more, such as about 1.2 g/cm³ or more, such as about 1.3 g/cm³ or more, such as about 1.4 g/cm³ or more, such as about 1.5 g/cm³ or more, such as about 1.6 g/cm³ or more, such as about 1.7 g/cm³ or more. The polyester may have a density of about 2 g/cm³ or less, such as about 1.9 g/cm³ or less, such as about 1.8 g/cm³ or less, such as about 1.7 g/cm³ or less, such as about 1.6 g/cm³ or less, such as about 1.5 g/cm³ or less, such as about 1.4 g/cm³ or less. The density may be determined in accordance with ISO 1183-1:2019.

Furthermore, it should be understood that a mixture of two or more polyesters, in particular thermoplastic polyesters, can be used. In one embodiment, the composition may contain one polyester as defined herein. In other embodiments, the composition may include a mixture of polyesters. For instance, more than one polyester, such as two or three polyesters, may be utilized in the composition.

In one embodiment, the composition and polymer may include a polyamide. For instance, the polyamide may be an aliphatic, a semi-aromatic, or an aromatic polyamide.

Polyamides generally have a CO—NH linkage in the main chain and can be obtained by condensation of a diamine and a dicarboxylic acid, by ring opening polymerization of lactam, or self-condensation of an amino carboxylic acid. For example, the polyamide may contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc .; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Of course, aromatic and/or alicyclic diamines may also be employed. Furthermore, examples of the dicarboxylic acid component may include aromatic dicarboxylic acids (e.g., terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc.), aliphatic dicarboxylic acids (e.g., adipic acid, sebacic acid, etc.), and so forth.

Examples of lactams include pyrrolidone, aminocaproic acid, caprolactam, undecanlactam, lauryl lactam, and so forth. Likewise, examples of amino carboxylic acids include amino fatty acids, which are compounds of the aforementioned lactams that have been ring opened by water.

In certain embodiments, an “aliphatic” polyamide may be employed that is formed only from aliphatic monomer units (e.g., diamine and dicarboxylic acid monomer units). Particular examples of such aliphatic polyamides include, for instance, nylon-4 (poly-α-pyrrolidone), nylon-6 (polycaproamide), nylon-11 (polyundecanamide), nylon-12 (polydodecanamide), nylon-46 (polytetramethylene adipamide), nylon-66 (polyhexamethylene adipamide), nylon-610, and nylon-612. Nylon-6 and nylon-66 are particularly suitable. In one particular embodiment, for example, nylon-6 or nylon-66 may be used alone. In other embodiments, blends of nylon-6 and nylon-66 may be employed.

Of course, it is also possible to include aromatic monomer units in the polyamide such that it is considered semi-aromatic (contains both aliphatic and aromatic monomer units) or wholly aromatic (contains only aromatic monomer units). For instance, suitable semi-aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephlhalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene lerephthalamide/dodecamelhylene dodecanediarnide) (PA12T/1212), poly(dodecamethylene terephthalamide/caprolactam) (PA12T/6), poly(dodecamethylene terephthalamide/hexamethylene hexanediamide) (PA12T/66), and so forth.

The polyamide employed may be crystalline or semi-crystalline in nature and thus have a measurable melting temperature. The melting temperature may be relatively high such that the composition can provide a substantial degree of heat resistance to a resulting part. For example, the polyamide may have a melting temperature of about 220° C. or more, in some embodiments from about 240° C. to about 325° C., and in some embodiments, from about 250° C. to about 335° C. The polyamide may also have a relatively high glass transition temperature, such as about 30° C. or more, in some embodiments about 40° C. or more, and in some embodiments, from about 45° C. to about 140° C. The glass transition and melting temperatures may be determined as is well known in the art using differential scanning calorimetry (“DSC”), such as determined by ISO Test No. 11357-2:2020 (glass transition) and 11357-3:2018 (melting).

The composition may generally comprise about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more of the polymer, such as the copolyether-ester, based on the weight of the composition. The composition may comprise less than 100 wt. %, such as about 98 wt. % or less, such as about 95 wt. % or less, such as about 93 wt. % or less, such as about 90 wt. % or less, such as about 87 wt. % or less, such as about 85 wt. % or less, such as about 83 wt. % or less, such as about 80 wt. % or less, such as about 75 wt. % or less, such as 70 wt. % or less, such as 65 wt. % or less, such as 60 wt. % or less, such as 55 wt. % or less, such as 50 wt. % or less, such as 45 wt. % or less, such as 40 wt. % or less, such as 35 wt. % or less of the polymer, such as the copolyether-ester, based on the weight of the composition.

In addition to the polymer as mentioned above, the composition may also include other optional additives as necessary to provide a resulting composition with the desired properties.

For instance, the composition may optionally include other additives as generally known in the art. These may include, but are not limited to, compatibilizers, pigments, colorants, dyes, dispersants, flame retardants, antioxidants, conductive particles, UV-inhibitors, UV-stabilizers, adhesion promoters, fatty acids, esters, paraffin waxes, neutralizers, tackifiers, dessicants, stabilizers, light stabilizers, light absorbers, coupling agents, plasticizers, lubricants, blocking agents, anti-blocking agents, antistatic agents, waxes, nucleating agents, slip agents, acid scavengers, metal deactivators, lubricants, adjuvants, polymeric additives, rubbers/elastomers, preservatives, thickeners, rheology modifiers, humectants, reinforcing and non-reinforcing fillers, and combinations thereof.

Such other additives may be provided in an amount as necessary. For instance, the additive, individually or in combination, may be provided in an amount of about 0.1 wt. % or more, such as about 0.2 wt. % or more, such as about 0.3 wt. % or more, such as about 0.4 wt. % or more, such as about 0.5 wt. % or more, such as about 0.6 wt. % or more, such as about 0.7 wt. % or more, such as about 0.8 wt. % or more, such as about 0.9 wt. % or more, such as about 1 wt. % or more, such as about 1.5 wt. % or more, such as about 2 wt. % or more, such as about 2.5 wt. % or more, such as about 3 wt. % or more, such as about 3.5 wt. % or more, such as about 4 wt. % or more, such as about 5 wt. % or more, such as about 8 wt. % or more, such as about 10 wt. % or more, such as about 15 wt. % or more, such as about 20 wt. % or more, such as about 25 wt. % or more based on the weight of the composition. The additive, individually or in combination, may be provided in an amount of about 40 wt. % or less, such as about 35 wt. % or less, such as about 30 wt. % or less, such as about 25 wt. % or less, such as about 20 wt. % or less, such as about 18 wt. % or less, such as about 15 wt. % or less, such as about 13 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2.5 wt. % or less, such as about 2 wt. % or less, such as about 1.5 wt. % or less, such as about 1.3 wt. % or less, such as about 1 wt. % or less, such as about 0.8 wt. % or less, such as about 0.7 wt. % or less, such as about 0.6 wt. % or less, such as about 0.5 wt. % or less, such as about 0.4 wt. % or less, such as about 0.3 wt. % or less, such as about 0.2 wt. % or less based on the weight of the composition.

### Composition Formation

The composition described herein can be processed using techniques generally known in the art. For instance, the components (copolyether-ester and other optional additives) may be melt-mixed (also referred to as melt-blended). Utilizing such an approach, the components may be well-dispersed throughout the composition. Furthermore, the components may be provided in a single-step addition or in a step-wise manner. The processing may be conducted in a chamber, which may be any vessel that is suitable for blending the composition under the necessary temperature and shearing force conditions. In this respect, the chamber may be a mixer, such as a Banbury™ mixer or a Brabender™ mixer, an extruder, such as a co-rotating extruder, a counter-rotating extruder, or a twin-screw extruder, a co-kneader, such as a Buss® kneader, etc. The melt blending may be carried out at a temperature ranging from 150 to 300° C., such as from 200 to 280° C., such as from 220 to 270° C. or 240 to 260° C. However, such processing should be conducted for each respective composition at a desired temperature to minimize any degradation. Upon completion of the mixing/blending, the composition may be milled, chopped, extruded, pelletized, or processed by any other desirable technique. In certain instances, the components may be melt-blended and directly fed to a downstream operation or molding apparatus for formation of a resulting molded part or article.

### Molded Parts

The composition is suitable for forming molded parts and articles as also described herein. In this regard, the composition may be molded into a molded part/article as described herein using conventional molding apparatuses and techniques, such as injection molding, extrusion molding, compression molding, blow molding, rotational molding, overmolding, thermoforming, etc. In general, these processes may include heating the composition to a temperature that is equal to or in excess of the melt temperature to form a pre-form for a mold cavity to then form the molded part, cooling the molded part to a temperature at or below the crystallization temperature, and releasing the molded part/article from a mold. The mold cavity defines the shape of the molded part/article as described herein. The molded part/article is cooled within the mold at a temperature at or below the crystallization temperature and the molded part/article can subsequently be released from the mold. The process may also utilize extrusion molding. In this regard, the composition may be extruded as described herein. Upon exiting the extruder, the composition may be formed or shaped to a desired part/article. Such part/article may be formed by using a particular die to shape the composition as it exits the extruder. Such shaping/forming process, such as the extrusion process, may be an automated or robotic process.

Features and advantages of this disclosure are apparent from the detailed specification, and the claims cover all such features and advantages. Numerous variations will occur to those skilled in the art, and any variations equivalent to those described in this disclosure fall within the scope of this disclosure. Those skilled in the art will appreciate that the conception upon which this disclosure is based may be used as a basis for designing other compositions and methods for carrying out the several purposes of this disclosure. As a result, the claims should not be considered as limited by the description or examples.

1-26. (canceled)

27. A non-pneumatic tire assembly comprising:
complementary annular inboard and outboard tire casing segments, each segment comprising:
a closed end and an open end,
a peripheral band comprising exterior and interior surfaces, and
an inner band comprising exterior and interior surfaces, the inner band being coaxially spaced radially inward from the interior surface of the peripheral band,
wherein the closed end comprises a resilient and contiguous sidewall extending radially between the interior surface of the peripheral band and the exterior surface of the inner band, the sidewall comprising convex or concave exterior and interior surfaces,
wherein the open end comprises a void defined by the interior surfaces of the peripheral band, the exterior surface of the inner band, and the sidewall;
wherein the inner band interior surfaces of the inboard and outboard tire casing segments are configured to be disposed on an exterior rim surface of a wheel such that the open ends of each segment do not form a sealed void within the inboard and outboard segments; and
wherein the annular inboard and outboard tire casing segments are each made from a composition comprising a copolyether-ester.

28. The non-pneumatic tire assembly of claim 27, wherein the copolyether-ester is prepared from (i) a monomer comprising poly(tetramethylene oxide) glycol, poly(trimethylene oxide) glycol, polypropylene oxide glycol, or any mixture thereof; (ii) a dicarboxylic acid selected from isophthalic acid, terephthalic acid, or any mixture thereof; and (iii) a diol selected from 1,4-butanediol, 1,3-propanediol, or any mixture thereof.

29. The non-pneumatic tire assembly of claim 27, wherein the copolyether-ester is prepared from (i) a monomer comprising poly(tetramethylene oxide) glycol; (ii) isophthalic acid, terephthalic acid, or any mixture thereof; and (iii) a diol selected from 1,4- butanediol, 1,3-propanediol, or any mixture thereof.

30. The non-pneumatic tire assembly of claim 27, wherein copolyether-ester is prepared from (i) a monomer comprising poly(tetramethylene oxide) glycol; (ii) a mixture of terephthalic acid and isophthalic acid, and (iii) 1,4-butanediol; or wherein the copolyether-ester is prepared from (i) a monomer comprising poly(tetramethylene oxide) glycol; (ii) terephthalic acid, and (iii) 1,4-butanediol.

31. The non-pneumatic tire assembly of claim 27, further comprising a contiguous tread layer extending radially outward from the peripheral band exterior surfaces of the inboard and outboard tire casing segments.

32. The non-pneumatic tire assembly of claim 31, wherein the tread layer is disposed directly on the peripheral band exterior surfaces of the inboard and outboard tire casing segments.

33. The non-pneumatic tire assembly of claim 31, wherein the tread layer comprises rubber.

34. The non-pneumatic tire assembly of claim 31, further comprising a shear band layer between the tread layer and the peripheral band exterior surfaces of the inboard and outboard tire casing segments.

35. The non-pneumatic tire assembly of claim 34, wherein the shear band layer comprises a thermoplastic polymer, or a reinforced rubber that is integral with the tread layer.

36. The non-pneumatic tire assembly of claim 35, wherein the thermoplastic polymer is an optionally reinforced polyester.

37. A wheel and non-pneumatic tire assembly comprising:
complementary annular inboard and outboard tire casing segments, each segment comprising:
a closed end and an open end,
a peripheral band comprising exterior and interior surfaces, and
an inner band comprising exterior and interior surfaces, the inner band being coaxially spaced radially inward from the interior surface of the peripheral band,
wherein the closed end comprises a resilient and contiguous sidewall extending radially between the interior surface of the peripheral band and the exterior surface of the inner band, the sidewall comprising convex or concave exterior and interior surfaces,
wherein the open end comprises a void defined by the interior surfaces of the peripheral band, the inner band, and the sidewall; and
a wheel or wheel assembly having an exterior rim surface;
wherein the inner band interior surface of the inboard and outboard tire casing segments are disposed on the exterior rim surface of the wheel such that the open ends of each segment do not form a sealed void within the inboard and outboard segments; and
wherein the annular inboard and outboard tire casing segments are each made from a composition comprising a copolyether-ester.

38. The wheel and non-pneumatic tire assembly of claim 37, wherein the copolyether-ester is prepared from (i) a monomer comprising poly(tetramethylene oxide) glycol, poly(trimethylene oxide) glycol, polypropylene oxide glycol, or any mixture thereof; (ii) a dicarboxylic acid selected from isophthalic acid, terephthalic acid, or any mixture thereof; and (iii) a diol selected from 1,4-butanediol, 1,3-propanediol, or any mixture thereof.

39. The wheel and non-pneumatic tire assembly of claim 37, wherein the copolyether-ester is prepared from (i) a monomer comprising poly(tetramethylene oxide) glycol; (ii) isophthalic acid, terephthalic acid, or any mixture thereof; and (iii) a diol selected from 1,4-butanediol, 1,3-propanediol, or any mixture thereof.

40. The wheel and non-pneumatic tire assembly of claim 37, wherein copolyether-ester is prepared from (i) a monomer comprising poly(tetramethylene oxide) glycol; (ii) a mixture of terephthalic acid and isophthalic acid, and (iii) 1,4-butanediol; or wherein the copolyether-ester is prepared from (i) a monomer comprising poly(tetramethylene oxide) glycol; (ii) terephthalic acid, and (iii) 1,4-butanediol.

41. The wheel and non-pneumatic tire assembly of claim 37, further comprising a contiguous tread layer extending radially outward from the peripheral band exterior surfaces of the inboard and outboard tire casing segments.

42. The wheel and non-pneumatic tire assembly of claim 41, wherein the tread layer is disposed directly on the peripheral band exterior surfaces of the inboard and outboard tire casing segments.

43. The wheel and non-pneumatic tire assembly of claim 41, wherein the tread layer comprises rubber.

44. The wheel and non-pneumatic tire assembly of claim 41, further comprising a shear band layer between the tread layer and the peripheral band exterior surfaces of the inboard and outboard tire casing segments.

45. The wheel and non-pneumatic tire assembly of claim 44, wherein the shear band layer comprises a thermoplastic polymer, or a reinforced rubber that is integral with the tread layer.

46. The wheel and non-pneumatic tire assembly of claim 37, wherein the wheel or wheel assembly is formed from a polyester-based composition, a thermoplastic polyamide, or a copolyether-ester.
